(19) United States
(12) Patent Application Publication
(10) Pub. No.: US 2014/0099979 A1
(43) Pub. Date: Apr. 10, 2014

(54) METHOD AND SYSTEM FOR POSITIONING MOBILE DEVICES

(71) Applicants: INVENTEC (PUDONG) TECHNOLOGY CORPORATION, Taipei (TW); INVENTEC CORPORATION, Taipei (TW)

(72) Inventor: Tzu-Chiang Chang, Taipei (TW)

(73) Assignees: INVENTIC CORPORATION, Taipei (TW); INVENTIC (PUDONG) TECHNOLOTY CORPORATION, Taipei (TW)

(21) Appl. No.: 13/790,998

(22) Filed: Mar. 8, 2013

(30) Foreign Application Priority Data
Oct. 9, 2012 (CN) 201210379909.3

(51) Int. Cl. H04W 4/04

(52) U.S. Cl. CPC H04W 4/04
USPC 455/457

(57) ABSTRACT

A method for positioning mobile devices includes steps of: a main device sending a first detection request to a plurality of peripheral devices; upon receiving the first detection request, each of the peripheral devices sending back a signal to the main device for recording; sending all obtained information back to the main device; and loading a visual interface having a plurality of device positions into the main device, the number of the device positions being equal to or more than the number of the peripheral devices; and the main device determining an orientation of each of the peripheral devices according to transmission times, and assigning the peripheral devices to the device positions in the visual interface.

### CROSS-REFERENCE TO RELATED APPLICATIONS

This non-provisional application claims priority under 35 U.S.C. §119(a) on Patent Application No(s). 201210379909.3 filed in China on Oct. 9, 2012, the entire contents of which are hereby incorporated by reference.

### BACKGROUND

1. Technical Field

The disclosure relates to a method and a system for positioning mobile devices, and more particularly to a method and a system for positioning a plurality of mobile devices at a short distance.

2. Related Art

With the rise of wireless networks, mobile computers may not only be used to browse web pages over the Internet, but also be used for data transmission. For conventional mobile computers, if it is intended to transmit a file between two mobile computers, the two mobile computers must be matched, only after which can data (or file) transmission be implemented.

Although the two mobile computers can exchange data after matching, such a method is limited to data transmission between the two mobile computers. In addition, in the existing matching method, a specific object must be selected in order to transfer data to the selected object. When it is intended to transfer a file to an unspecified mobile computer of the person in a conference room or office, the mobile computer of the person often cannot be determined according to the name of the detected mobile computer on the menu, that is, the positions of other mobile computers cannot be determined through the menu. In this case, the user has to remember the name of the mobile computer of the person on the menu. Therefore, the user cannot intuitively transmit a file to the mobile computer of the person whom the user wants to send to.

The Global Positioning System may be used to obtain the approximate position of each mobile computer. However, if all the users (mobile computers) go indoors, the Global Positioning System cannot obtain the accurate positions of their mobile computers. As a result, the user cannot obtain the positions of other mobile computers from the menu.

### SUMMARY

The method for positioning mobile devices disclosed in the disclosure comprises: a main device sending a first detection request to a plurality of peripheral devices; upon receiving the first detection request, each of the peripheral devices sending back a signal to the main device for recording; and loading a visual interface having a plurality of device positions into the main device, the number of the device positions being equal to or more than the number of the peripheral devices; and the main device determining an orientation of each of the peripheral devices according to transmission times, and assigning the peripheral devices to the device positions in the visual interface.

The disclosure also provides a system for positioning mobile devices, comprising: a plurality of peripheral devices, each having a first wireless transmission module; and a main device, having a processing unit, a storage unit, a second wireless transmission module and a display unit, the processing unit being connected to the second wireless transmission module, the storage unit and the display unit, and the storage unit being adapted to store a visual interface and a file. The visual interface is adapted to record a plurality of device positions. The processing unit drives the second wireless transmission module to send a detection request to the peripheral devices, the peripheral devices each return a transmission time to the main device in response to the first detection request, and the processing unit sets the corresponding peripheral device to each device position in the visual interface according to the transmission times.

### BRIEF DESCRIPTION OF THE DRAWINGS

The disclosure will become more fully understood from the detailed description given herein below for illustration only, and thus are not limitative of the disclosure, and wherein:

FIG. 1 is a block diagram of the disclosure;

FIG. 2A is a schematic view of a device position page according to the disclosure;

FIG. 2B is a schematic view of another device position page according to the disclosure;

FIG. 3A is a schematic operational flowchart of a positioning process according to the disclosure;

FIG. 3B is a schematic operational flowchart of a visual interface according to the disclosure;

FIG. 4A is a schematic view of a main device and peripheral devices according to the disclosure;

FIG. 4B is a schematic view of assignment of peripheral devices to device positions according to the disclosure;

FIG. 4C is a schematic view of file dragging according to the disclosure;

FIG. 4D is a schematic architectural view of file transmission according to the disclosure;

FIG. 5A is a schematic flowchart of another embodiment according to the disclosure;

FIG. 5B is a schematic view illustrating operation of another embodiment according to the disclosure;

FIG. 5C is a schematic view illustrating operation of another embodiment according to the disclosure; and

FIG. 5D is a schematic view illustrating operation of another embodiment according to the disclosure.

### DETAILED DESCRIPTION

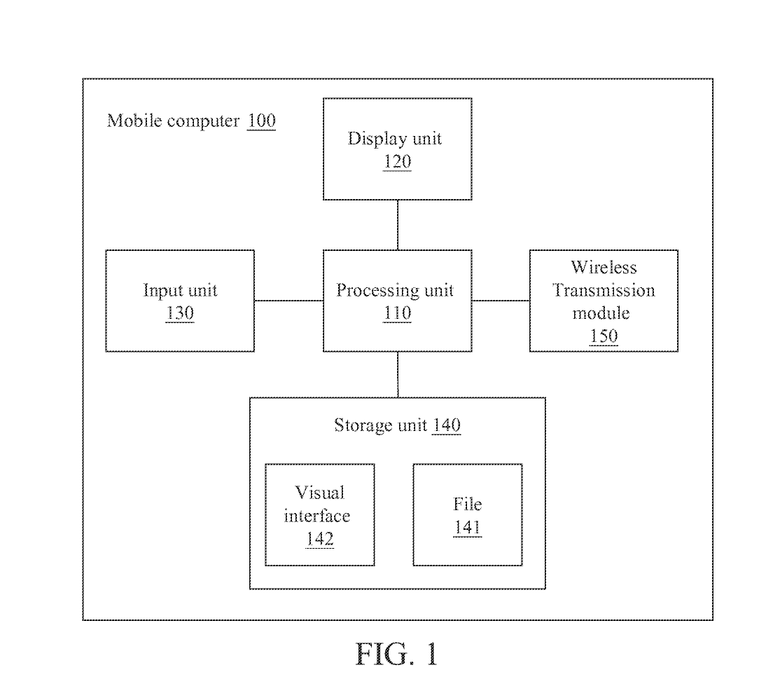

FIG. 1 is a block diagram according to an embodiment of the disclosure. The mobile computer described in the disclosure can be a mobile phone, a tablet computer or a personal digital assistant, and even can generally refer to a notebook computer. The mobile computer in the disclosure can run different operation systems, such as iOS, Android, Windows, Symbian or Blackberry. The mobile computer 100 in the disclosure comprises a processing unit 110, a display unit 120, an input unit 130, a storage unit 140 and a wireless transmission module 150. The processing unit 110 is electrically connected to the display unit 120, the input unit 130, the storage unit 140 and the wireless transmission module 150.

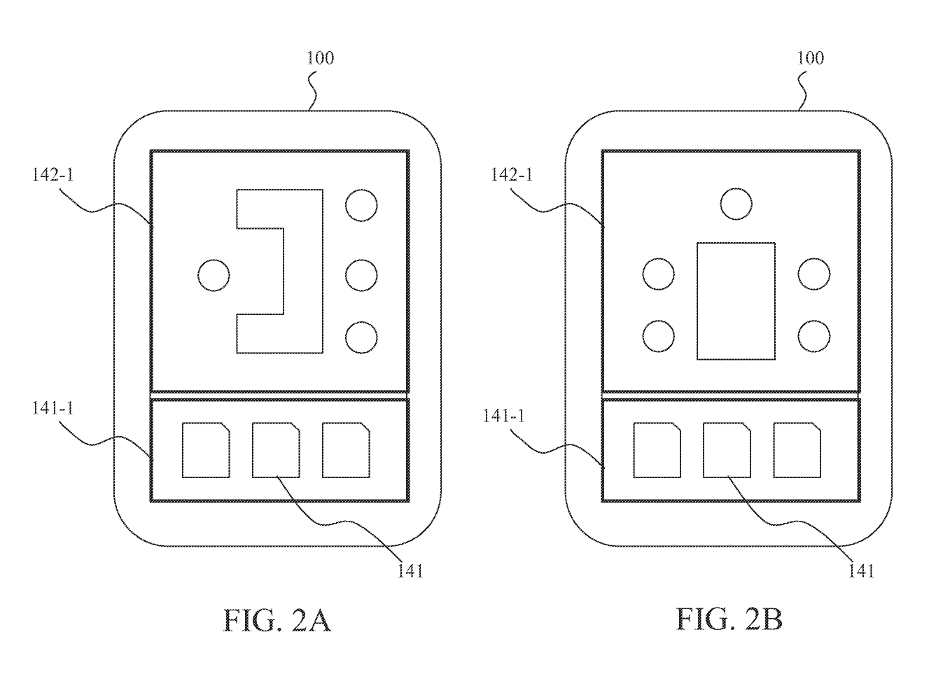

The display unit 120 is used to show a visual interface 142. The visual interface 142 further comprises a file menu page 142-1 and a device position page 142-2 (as shown in FIG. 2A to FIG. 2B). The file menu page 142-1 displays a plurality of files 141, allowing a user to select the file 141 to be transmitted. The device position page 142-2 is used to display the position of each mobile computer 100. The method for obtaining the position of the mobile computer 100 will be described in detail below.

For the device position frame in the disclosure, various frames may be provided according to the places where the user may be in. For example, if the user is in a conference room, the visual interface 142 may provide conference tables of different types for selection by the user. In each of the device position frame, a plurality of device positions exists. Each device near the user is assigned to one of the device positions, and therefore, the number of device positions is equal to or more than that of devices near the user. In some embodiments, the device positions (and the number thereof) in the device position frame are preset by the operation system or set by the user, or are determined by the detection of the user's mobile computer (the detection method will be described in detail below).

The user may perform a corresponding operation on a main device (e.g. the user's mobile computer) through an input device. Generally speaking, the input device may be a keyboard, a touchpad or a joystick. In some embodiments, the input device is built in the display unit 120. For example, a touch screen may be used as the input unit 130 and the display unit 120 in the disclosure.

The storage unit 140 not only records the files 141, but also stores the visual interface 142. The processing unit 110 obtains the file 141 and the visual interface 142 from the storage unit 140 and performs corresponding processes. The processing unit 110 exchanges data with other mobile computers 100 through the wireless transmission module 150.

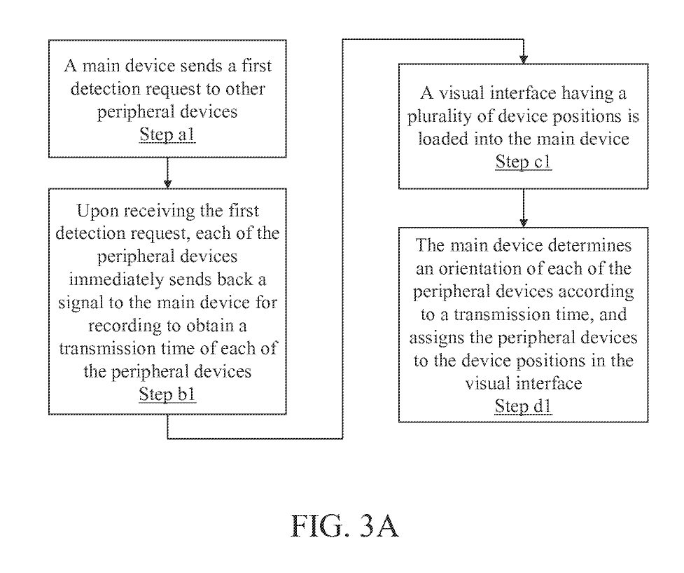

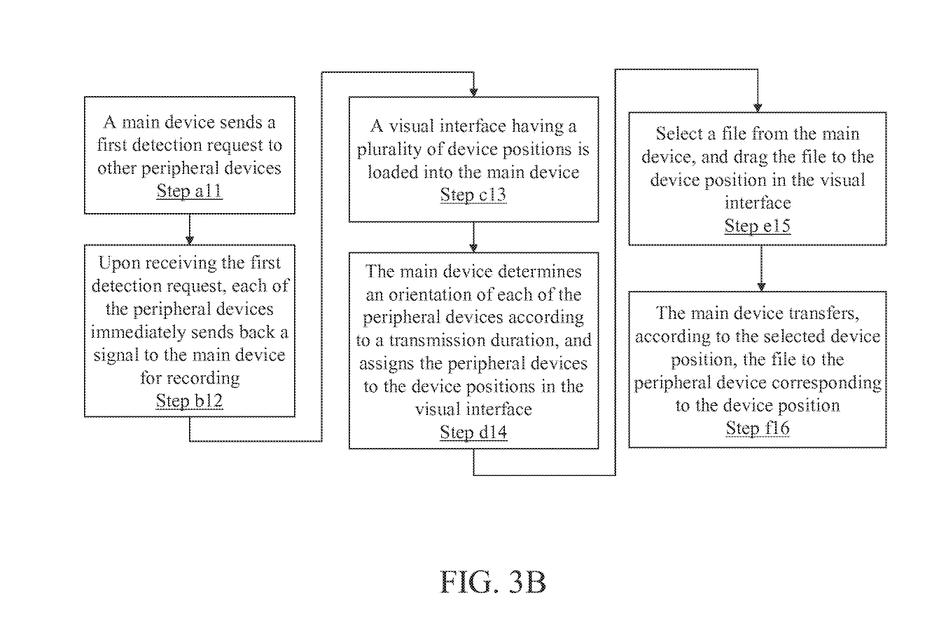

Refer to FIG. 3A, which is a schematic flowchart of positioning devices according to the disclosure. The positioning process in the disclosure comprises the following steps:

step a1: a main device sending a first detection request to peripheral devices near the main device;

step b1: upon receiving the first detection request, each of the peripheral devices immediately sending back a signal to the main device for recording to obtain a transmission time of each of the peripheral devices;

step c1: loading a visual interface having a plurality of device positions into the main device; and

step d1: the main device determining the orientation of each of the peripheral devices according to a transmission time, and assigning the peripheral devices to the device positions in the visual interface.

To clearly illustrate the roles of different mobile computers 100, the mobile computer 100 sending the first detection request is defined as the main device (not marked), and the other mobile computers 100 are defined as the peripheral devices (not marked). The main device first sends the first detection request to the other peripheral devices. At this time, the main device show the visual interface 142 by the display unit 120, where the visual interface 142 comprises the file menu page 142-1 and the device position page 142-2.

The file menu page 142-1 may display various files 141, relevant directories or interactive functions (for example, real-time communication or video) in the form of a list or icons. The user may select the same or similar graphics from the device position page 142-2 according to the place where the user is in. For example, the user can select a graphic corresponding to the conference table near the user. Once the shape of the graphic according to the conference table is decided, and the positions of the main device and the peripheral devices can be assigned around the conference table on the display unit 120. After the user selects the graphic, the main device requires the user to set the position of the main device in the graphic, and enter the number of the peripheral devices in the current occasion. Alternatively, the main device determines the number of the nearby peripheral devices according to the response to the first detection request.

In the disclosure, besides the device positioning method, the following file transmission processes may further be performed according to the result of positioning. FIG. 3B is a schematic operational flowchart of a visual interface according to the disclosure. The file transmission processing in the disclosure comprises the following steps:

step a11: a main device sending a first detection request to peripheral devices;

step b12: upon receiving the first detection request, each of the peripheral devices immediately sending back a signal to the main device for recording;

step c13: loading a visual interface having a plurality of device positions into the main device;

step d14: the main device determining the orientation of each of the peripheral devices according to a transmission time, and assigning the peripheral devices to the device positions in the visual interface;

step e15: selecting a file from the main device, and dragging the file to the device position in the visual interface corresponding to the peripheral device to which the file is intended to be sent to; and

step f16: the main device sending, according to the selected device position, the file to the peripheral device corresponding to the device position.

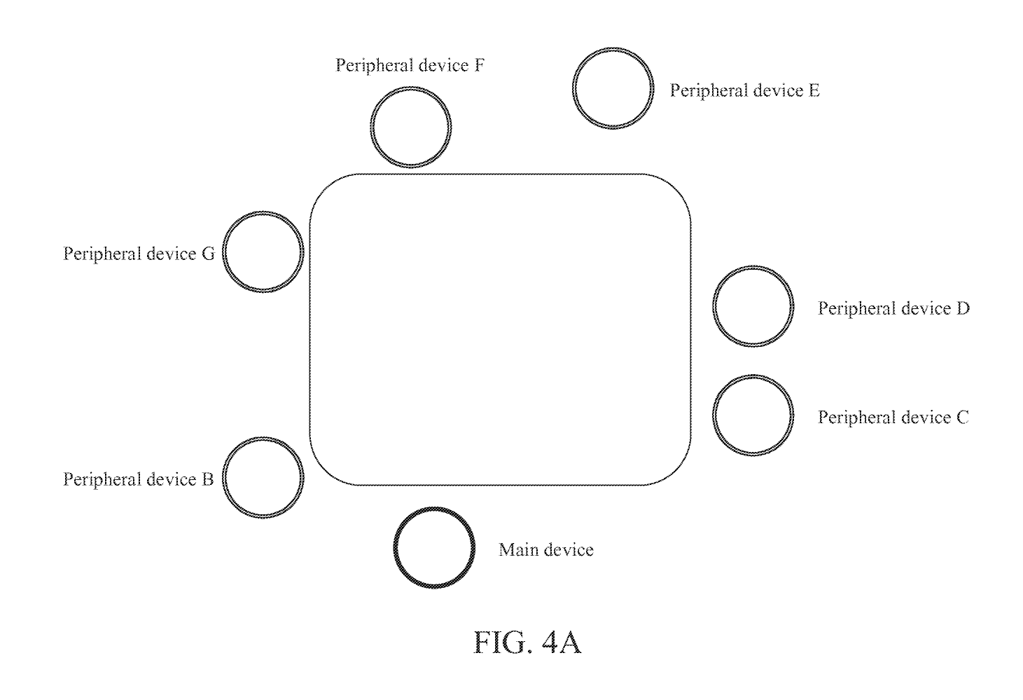

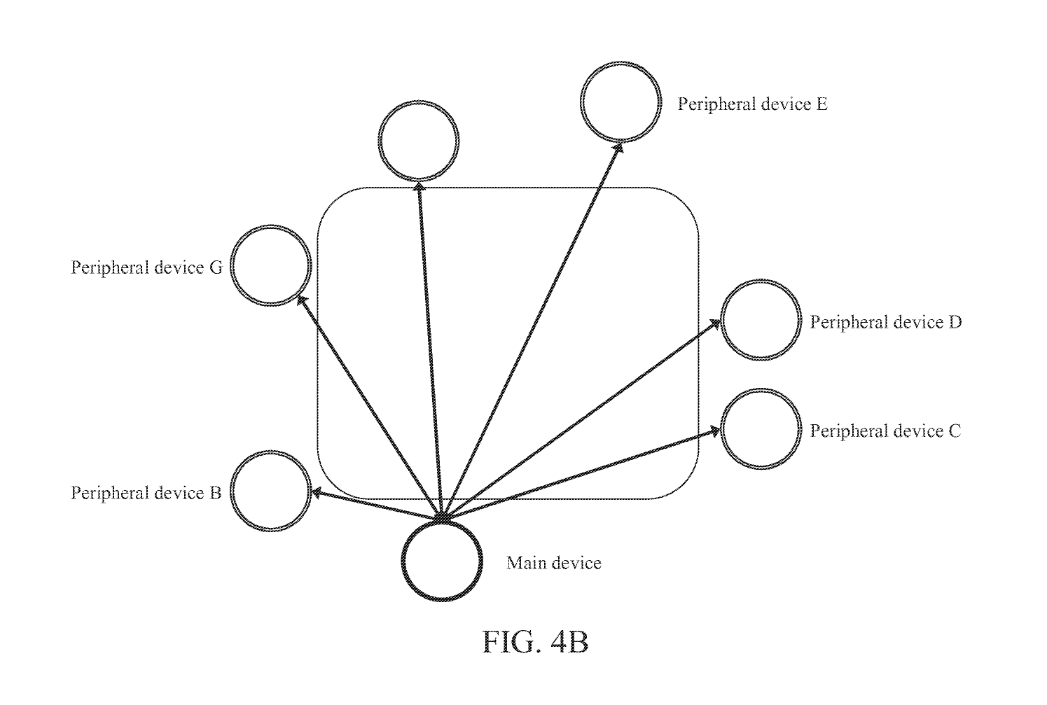

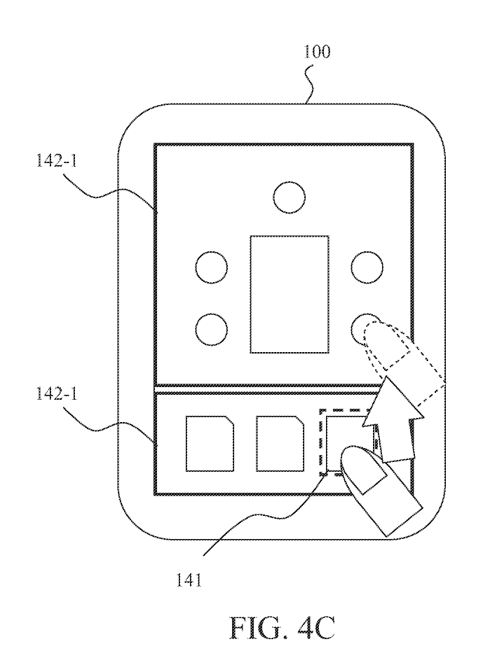

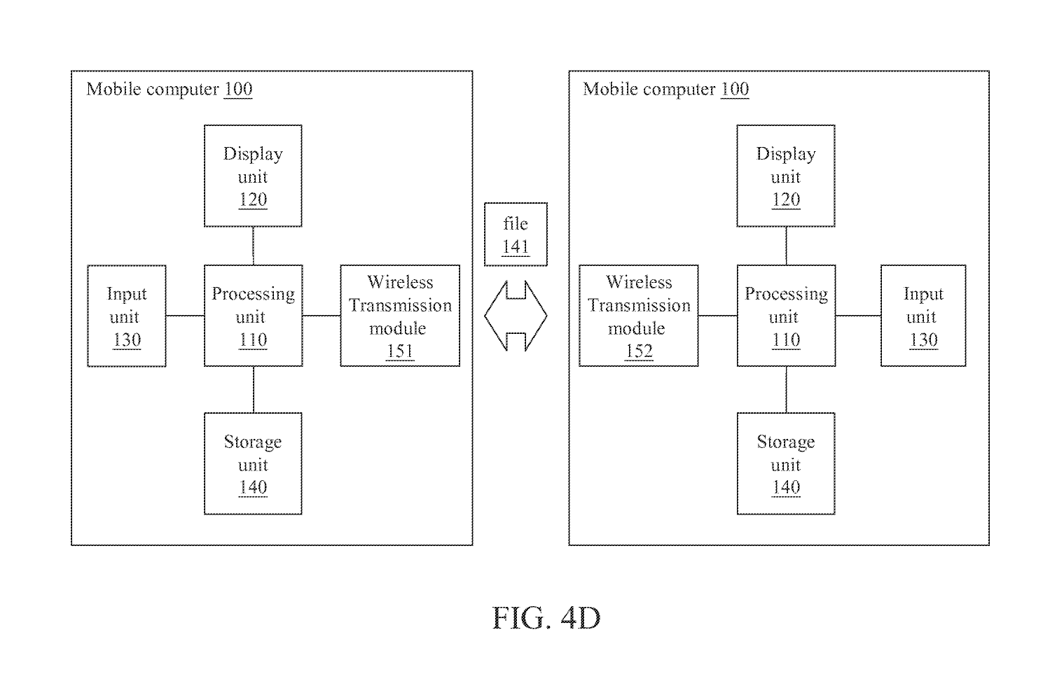

An example is given below. The main device detects the number and positions of the peripheral devices according to the result of the first detection request; however, it should be noted that the number in the example is not limited thereto. If a main device A sends the first detection request, and there are six peripheral devices, namely, a peripheral device B, a peripheral device C, a peripheral device D, a peripheral device E, a peripheral device F and a peripheral device G. Referring to FIG. 4A, the peripheral devices are denoted by dual-line black circles, and the main device is denoted by a single-line black circle. FIG. 4A merely shows how many peripheral devices exist, but no corresponding peripheral device is assigned to each of the device positions. The transmission protocol between mobile communication devices is a wireless transmission technology such as IEEE 802.11 series or Bluetooth.

After the main device A performs broadcasting through a wireless network, the other peripheral devices (B, C, D, E, F and G) sequentially receive a packet carrying the first detection request. After receiving the packet carrying the first detection request, the peripheral devices (B, C, D, E, F and G) immediately send back a signal to the main device A, and the main device A records a transmission time from sending of the first detection request to receiving the signal from each of the peripheral devices, so as to obtain the transmission time of the first detection request. The main device A determines a distance between it and each of the peripheral devices (B, C, D, E, F and G) according to the transmission time. The main device A assign the peripheral devices into positions around the conference table of the device position page 142-2 according to the distances, respectively. And the main device may transfers the created visual interface to the peripheral devices.

The transmission times of the peripheral devices are shown in the following table:

TABLE 1
List of transmission times of peripheral devices

| Name of peripheral device | Transmission time (ms) |
|---|---|
| Peripheral device B | 1.8 |
| Peripheral device C | 3.6 |
| Peripheral device D | 5.2 |
| Peripheral device E | 4.8 |
| Peripheral device F | 3.9 |
| Peripheral device G | 3.5 |

In a case where devices is not many in an indoor environment, the probability of packet collision and congestion is small, and therefore, it may be considered that no interference occurs during transmission in the wireless network. The main device A can thus determine the distances of the peripheral devices (B, C, D, E, F and G) according to the transmission times. FIG. 4B is a schematic view of assignment of peripheral devices to device positions according to the disclosure. In this embodiment, the main device A determines the distance of the peripheral device according to the length of the transmission time. If the result of arrangement is wrong, the main device A may allow the user to manually adjust the positions of the peripheral devices.

After the main device A determines the positions of the peripheral devices (B, C, D, E, F and G) in the device position page 142-2, the user may select any file 141 from the file menu page 142-1, as shown in FIG. 4C and FIG. 4D. Then, the user drags the file 141 to any peripheral device (B, C, D, E, F or G) in the device position page 142-2. In FIG. 4C, the finger denoted by black solid lines represents a finger of the user, the arrow direction represents an object to be transmitted by the user, and the finger denoted by dashed lines represents the position of the finger of the user after dragging the selected file 141 to the specified device. The processing unit 110 determines the corresponding peripheral device (B, C, D, E, F or G) according to the destination device position of dragging, and transfers the selected file 141 to the specified peripheral device through the first wireless transmission module 151 (that is, the wireless transmission module 150). The peripheral device (B, C, D, E, F or G) receives the transferred file 141 through the second wireless transmission module 152 (that is, the wireless transmission module 150). Thereby, the user can view the positions of the peripheral devices through the display unit 120.

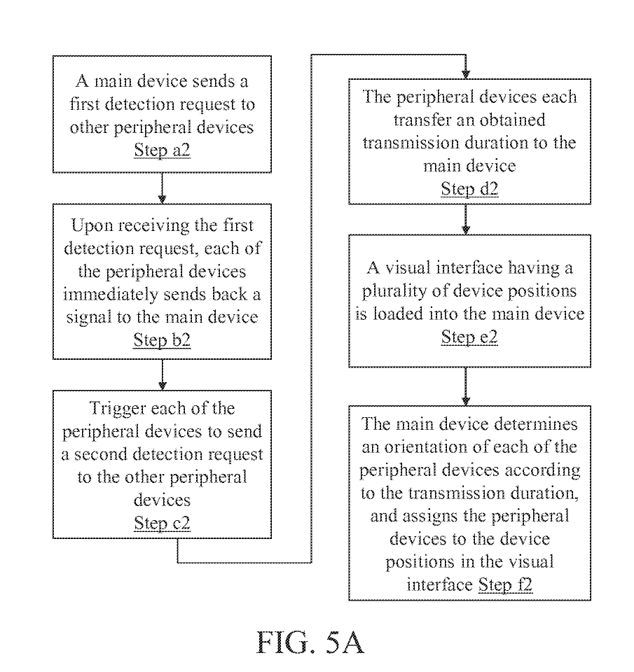

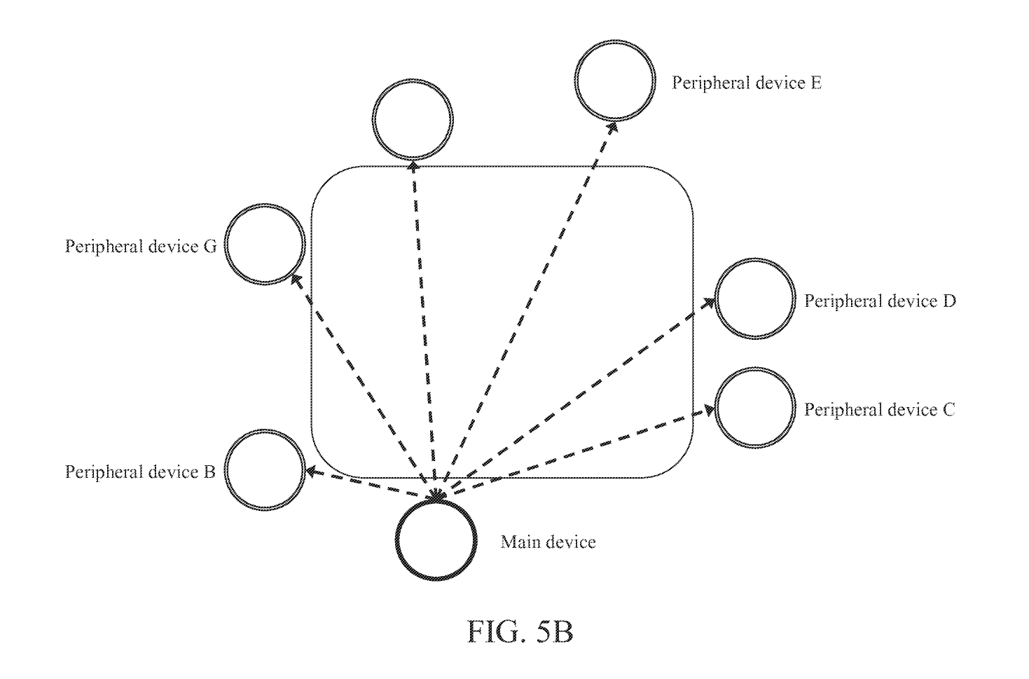

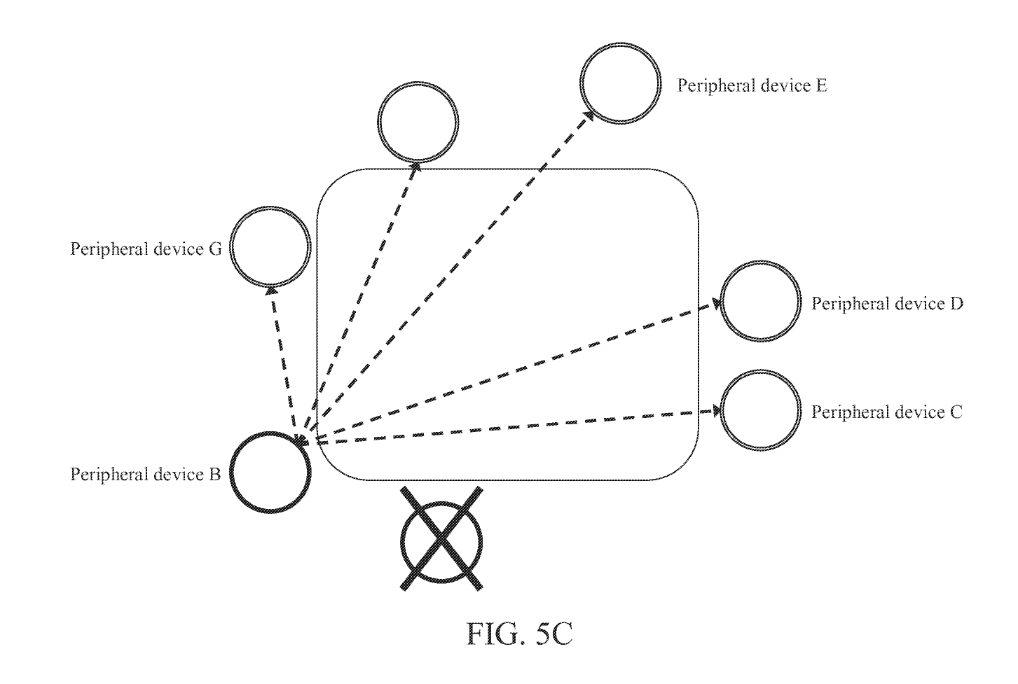

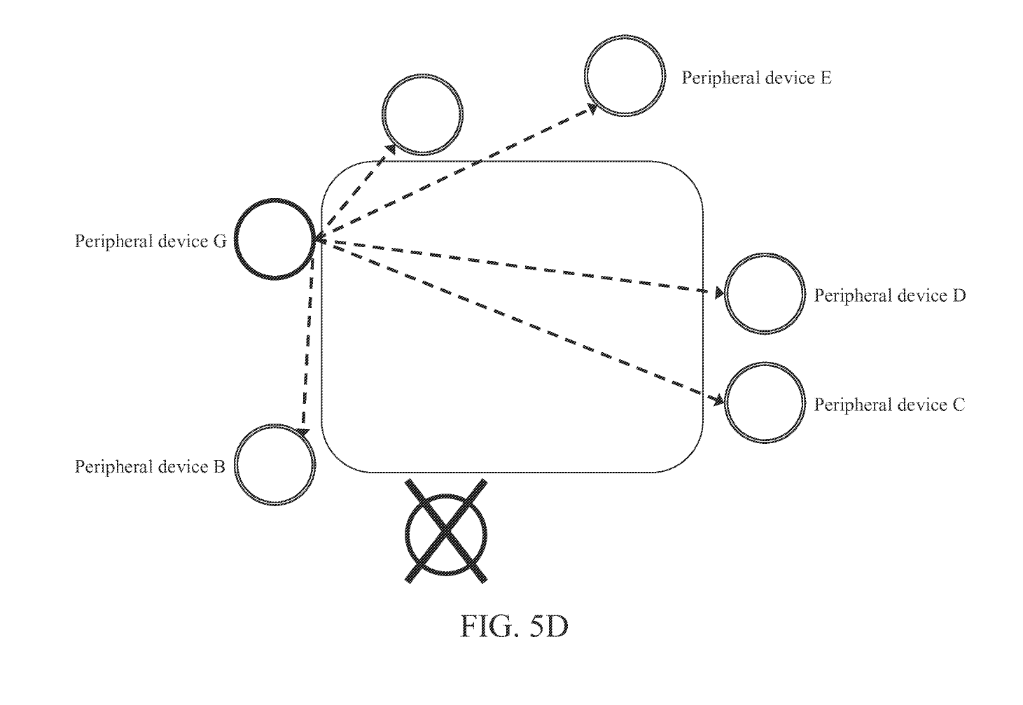

In addition to the use of time difference, the positioning of the peripheral devices may be done by the peripheral devices. FIG. 5A is a schematic flowchart of another embodiment according to the disclosure. This embodiment comprises the following steps:

step a2: a main device sending a first detection request to other peripheral devices;

step b2: upon receiving the first detection request, each of the peripheral devices immediately sending back a signal to the main device;

step c2: triggering each of the peripheral devices to send a second detection request to the other peripheral devices;

step d2: the peripheral devices each sending an obtained transmission time to the main device;

step e2: loading a visual interface having a plurality of device positions into the main device; and

step f2: the main device determining an orientation of each of the peripheral devices according to the transmission times, and assigning the peripheral devices to the device positions in the visual interface.

In addition to that the main device obtains the transmission time from the peripheral device, each peripheral device may obtain the transmission times between the peripheral device and the other peripheral devices. If the peripheral devices are too close in distance to each other, the transmission times will be similar, leading to blind spots in determination by the main device. To solve the problem, the disclosure further provides this embodiment.

When sending the detection request, the main device A obtains the transmission times of the peripheral devices (B, C, D, E, F and G) by the method as described above. In this embodiment, the first detection request sent by the main device A triggers the peripheral devices (B, C, D, E, F and G) to respectively send a new second detection request. For example, the peripheral device B sends the second detection request to the other peripheral devices (C, D, E, F and G), as shown in FIG. 5B to FIG. 5D. In FIG. 5B to FIG. 5D, black dashed lines denote that the peripheral device B sends the second detection request to the other peripheral devices (C, D, E, F and G). The peripheral device B may not send the second detection request to the main device A, and in FIG. 5B to FIG. 5D, “X” is used to mark the mobile computer 100 that will not receive the detection request. The second detection request sent by the peripheral device B will not trigger the other peripheral devices to send a detection request. The peripheral devices (B, C, D, E, F and G) may also send the second detection request to the other peripheral devices, and transfer the obtained transmission time to the main device A, respectively. Table 2 is a list of transmission times between the peripheral devices.

TABLE 2
List of transmission times between peripheral devices

| | Transmission | | |
|---|---|---|---|
| Name of | time (with the | Connected | |
| peripheral device | main device) | peripheral devices | Response time |
| B | 1.8 | C, D, E, F, G | 1.3, 3.6, 3.7, 3.5, 4 |
| C | 3.6 | B, D, E, F, G | 1.3, 1.3, 2.4, 3, 4.1 |
| D | 5.2 | B, C, E, F, G | 3.6, 1.3, 1.5, 2.9, |
| | | | 4.6 |
| E | 4.8 | B, C, D, F, G | 3.7, 2.4, 1.5, 1.1, |
| | | | 2.8 |
| F | 3.9 | B, C, D, E, G | 3.5, 3, 2.9, 1.1, 1.1 |
| G | 3.5 | B, C, D, E, F | 4, 4.1, 4.6, 2.8, 1.1 |

The main device A determines the positions of the peripheral devices (B, C, D, E, F and G) according to the transmission times between the peripheral devices (B, C, D, E, F and G) by edge and node computation in computer graphics. After the main device A completes the computation, the main device fills the peripheral devices (B, C, D, E, F and G) to corresponding positions in the device position page. And the main device may transfers the created visual interface 142 to the peripheral devices. After the visual interface 142 is created, the user may drag the file 141 to be transferred to any peripheral device in the device position page 142-2.

The method and system for wireless file transmission provided in the disclosure enable the user to directly transfer a file to the mobile computer 100 at the orientation similar to that of the mobile computer in the visual interface 142. The user does not need to remember the owner of the mobile computer 100 in the conventional menu. Thereby, the convenience in use is improved, and the probability of false transmission is reduced.

What is claimed is:

1. A method for positioning mobile devices, applied in an indoor space to identify positions of a plurality of mobile devices, the method comprising:
step a: a main device sending a first detection request to a plurality of peripheral devices;
step b: upon receiving the first detection request, each of the peripheral devices sending back a signal to the main device for recording to obtain a transmission time of each of the peripheral devices;
step c: loading a visual interface having a plurality of device positions into the main device; and
step d: the main device determining an orientation of each of the peripheral devices according to transmission times, and assigning the peripheral devices to the device positions in the visual interface.

2. The method for positioning mobile devices according to claim 1, wherein the step a comprises:
step a-1: the main device selecting a wireless transmission protocol; and
step a-2: the main device sending the first detection request to the peripheral devices according to the wireless transmission protocol.

3. The method for positioning mobile devices according to claim 1, wherein after the step c, the method further comprises step c-1:
triggering the peripheral device to send a second detection request to the other peripheral devices; and
the peripheral devices sending the obtained transmission times to the main device.

4. The method for positioning mobile devices according to claim 3, wherein the step of sending the second detection request further comprises: the main device will not receive the detection request.

5. The method for positioning mobile devices according to claim 1, wherein after the step d, the method further comprises:
step e: selecting a file from the main device, and dragging the file to the device position in the visual interface; and
step f: the main device sending, according to the selected device position, the file to the peripheral device corresponding to the device position.

6. The method for positioning mobile devices according to claim 1, wherein in the step c, the number of the device positions is equal to or more than the number of the peripheral devices.

7. A system for positioning mobile devices, comprising:
a plurality of peripheral devices, each having a first wireless transmission module; and
a main device, having a processing unit, a storage unit, a second wireless transmission module and a display unit, the processing unit being connected to the second wireless transmission module, the storage unit and the display unit, the storage unit being adapted to store a visual interface and a file, and the visual interface being adapted to record a plurality of device positions,
wherein the processing unit drives the second wireless transmission module to send a detection request to the peripheral devices, the peripheral devices each return a signal to the main device for recording to obtain a transmission time of each of the peripheral devices, and the processing unit sets the corresponding peripheral device to each device position in the visual interface according to the transmission times.

8. The system for positioning mobile devices according to claim 7, wherein the main device and the peripheral devices are notebook computers, mobile phones, tablet computers or personal computers.

9. The system for positioning mobile devices according to claim 7, wherein the main device transfers the created visual interface to the peripheral devices.

10. The system for positioning mobile devices according to claim 7, wherein the processing unit receives a drag command and transfers the selected file to the peripheral device at the corresponding position through the first wireless transmission module.
